(19) United States
(12) Patent Application Publication
(10) Pub. No.: US 2017/0364853 A1
(43) Pub. Date: Dec. 21, 2017

(54) METHOD OF TRAINING MULTILINE INSURANCE AGENTS

(71) Applicant: Risk Advisor Institute, LLC, Charlotte, NC (US)

(72) Inventor: William Cannon Whitley, Charlotte, NC (US)

(73) Assignee: Risk Advisor Institute, LLC, Charlotte, NC (US)

(21) Appl. No.: 15/187,181

(22) Filed: Jun. 20, 2016

(51) Int. Cl. G06Q 10/06; G09B 5/02; G09B 19/00; G09B 29/00

(52) U.S. Cl. CPC G06Q 10/06398; G09B 29/00; G09B 5/02; G09B 19/00

(57) ABSTRACT

A method includes training multiline insurance agents on having a conversation with the insured for discovering the insured's financial situation and risks by creating a visual diagram of the insured's financial situation and risks. The diagram includes the insured's name at the center of the visual diagram including an income box of the insured's household income. A family box is drawn from the income box with a family tree of the insured's family thereunder. An assets box is drawn from the income box with an asset listing of the insured's listing thereunder. A listing of risks is drawn at the bottom of the visual diagram. A box is drawn around the insured's name, the income box, the family box with the family tree, and the assets box with the asset listing, where the bottom of the box provides a boundary between the listing of risks and the family box and assets box.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND

### Technical Field of the Disclosure

The disclosure generally relates to insurance and insurance agents. More specifically, the instant disclosure relates to a method of training multiline insurance agents.

### Description of the Related Art

The disclosure relates generally to methods of training multiline insurance agents in various fields of insurance, including, but not limited to, auto insurance, casualty insurance, property insurance, liability insurance, umbrella insurance, gap insurance, health insurance, income protection insurance, life insurance, burial insurance, credit insurance, the like, etc.

Insurance is a form of risk management for protection from financial loss and is primarily used to hedge against the risk of a contingent, uncertain loss. An entity which provides insurance is known as an insurer, insurance company, or insurance carrier. A multiline insurer or multiline insurance agent is an insurance company or independent agent that provides a one-stop shop for businesses or individuals seeking coverage for some or all of their insurance needs. For example, many large insurers offer individual policies for automobile, homeowner, long-term care, life and health insurance needs.

A person or company who buys insurance is known as an insured or policyholder. The insurance transaction involves the insured assuming a guaranteed and known relatively small loss in the form of payment to the insurer in exchange for the insurer's promise to compensate the insured in the event of a covered loss. The loss may or may not be financial, but it must be reducible to financial terms, and must involve something in which the insured has an insurable interest established by ownership, possession, or preexisting relationship. The insured receives a contract, called the insurance policy, which details the conditions and circumstances under which the insured will be financially compensated. The amount of money charged by the insurer to the insured for the coverage set forth in the insurance policy is called the premium. If the insured experiences a loss which is potentially covered by the insurance policy, the insured submits a claim to the insurer for processing by a claims adjuster.

An insurance agent, also known as a broker, sells, solicits, or negotiates insurance for compensation. Although most times insurance “agent” and insurance “broker” are used interchangeably as they must obtain a broker's license, this is not always the case. An insurance agent may technically be an insurance company's representative by way of agent-principal legal custom. The agent's primary alliance is with the insurance carrier, not the insurance buyer. In the United States, insurance agents/brokers are regulated by the states. Most states require anyone who sells, solicits, or negotiates insurance in that state to obtain an insurance broker license, with certain limited exceptions. In order to obtain a broker's license, a person typically must take pre-licensing courses and pass an examination. An insurance agent also must submit an application and fee to the state insurance regulator in the state in which the applicant wishes to do business. Once licensed, an insurance agent/broker generally must take continuing education courses. However, these classes are limited to the obligations of the broker and understandings of insurance, and typically do not teach the agent/broker how to conduct business and garner clients.

Insurance agents play a significant role in helping companies and individuals procure property and casualty (liability) insurance, life insurance and annuities, and accident and health insurance. For example, research shows that agents play a significant role in helping small employers find health insurance, particularly in more competitive markets. Brokers provide services beyond procuring insurance, such as providing risk assessments, insurance consulting services, insurance-related regulatory and legislative updates, claims assistance services, assisting with employee enrollment, and helping to resolve benefit issues. Negligence on the part of insurance brokers can have severe effects upon insureds when they discover their insurance coverage is worthless, which in turn illustrates why retaining a competent insurance agent is so important.

A multiline contract is a type of insurance policy that bundles together exposures to risk and covers them under a single contract with a common aggregate deductible and policy limit. A common multiline contract combines property and casualty risks together into a single policy. A multiline contract is attractive because a common aggregate deductible can be offered on a policy portfolio that covers several risk types. Some insurance companies prefer this policy type because it allows them to reduce risk by spreading it among several factors, which helps them avoid a huge financial burden in the event of a catastrophe. Holding multiple policies with the same insurer may trigger premium discounts for the insured and allow him or her to consolidate insurance policies with the same carrier. On the other hand, an insurance company that writes multiple insurance contracts on a customer garners more premium profits and improves insured retention by keeping competitors away. As such, there is always a need or desire to train multiline insurance agents to attract more policyholders or insured clients, close more sales and deepen relationships with insured clients.

Therefore, it is readily apparent that there is a recognizable unmet need for a method of training multiline insurance agents. The instant disclosure is designed to address at least some of the above mentioned problems by providing a method of training insurance agents.

### SUMMARY

Briefly described, in a possibly preferred embodiment, the present method overcomes the above-mentioned disadvantages and meets the recognized need for such a method of training multiline insurance agents. The present method generally includes training multiline insurance agents on having a conversation with an insured for discovering an insured's financial situation and risks. This discovery is enabled by creating a visual diagram of the insured's financial situation and risks based on the conversation with the insured.

According to its major aspects and broadly stated, the present disclosure describes a method of training multiline insurance agents to utilize a visual diagram that generally includes an insured's name at a center of the visual diagram. Along with the insured's name, an income box of the insured's household income is included at the center of the visual diagram. A family box may then be branched off from the income box with a family tree of the insured's family thereunder. An assets box may also be branched off from the income box with an assets row of the insured's assets listed therein. The family box and the assets box may be branched off from the income box in different directions to show the two different areas that the insured may use their household income for supporting family and purchasing assets. A risks row may then be created at the bottom of the diagram. The risks row may include the insured's risks listed therein. A box may then be drawn around the insured's name, the income box, the family box with the family tree, and the assets box with the assets row, where the box provides a boundary between the risks row and the family box and assets row. The visual diagram of the insured's financial situation and risks may be created based on an in-person conversation between the multiline insurance agent and the insured.

In select embodiments, the method of training multiline insurance agents may also include training the multiline insurance agent to repeat what they have heard the insured say periodically throughout the discovery conversation, or at least after creating the income box, family box with family tree, and assets box with the assets listing. This repeating of what they have heard may be for letting the insured know they were listening and for assuring the accuracy of the insured's discovered financial situation and risks.

In other select embodiments, the method of training multiline insurance agents may also include, when drawing the box with the boundary between the listing of risks and the family box and assets box, training the multiline insurance agent to discuss their role in being a risk manager by creating a wall between their discovered financial situation and the insured's risks in the risks row.

In other select embodiments, the method of training multiline insurance agents may also include training the multiline insurance agent to discuss with the insured each of their risks in the risks row and discover the insured's coverage for each of their risks and a prioritization of the listing of risks from the insured.

In other select embodiments, the method of training multiline insurance agents may also include training the multiline insurance agent to recommend insurance coverage based on the discovered financial situation and risks and the insured's prioritization of the listing of risks.

One feature of the disclosed method of training multiline insurance agents may be that the insured's risks listed in the risks row of the visual diagram may include: health, disability, life, longevity, home, auto, liability, the like, combinations thereof, and any other risks associated with the insured. In select embodiments, the listing of risks may consist of: health, disability, life, longevity, home, auto, and liability.

Another feature of the disclosed method of training multiline insurance agents may be that the family tree created in the visual diagram may include: the insured, the spouse, children, parents, spouse's parents, the like, combinations thereof, or any other individuals inside or outside of the insured's family that the insured desires to disclose. In select embodiments, the family tree may consist of: the insured, the spouse, their children, the insured's parents, and the spouse's parents.

Another feature of the disclosed method of training multiline insurance agents may be that the insured's assets listed in the assets row created in the visual diagram may include: a car or cars including a car type and a car value, a home or homes including a home value, investments including an investment type and an investment value, the like, combinations thereof, or any other various assets the insured may disclose. In select embodiments, the insured's assets listed in the assets row may consist of: the car or cars, the home or homes, and the investments.

Another feature of the method of training multiline insurance agents, may be that in select embodiments the visual diagram may be created on paper, markerboard, an electronic slideshow presentation, the like, combinations thereof, or other various means for creating a visual representation of the insured's financial situation and risks. In select embodiments, the method may further include saving a copy of the visual diagram in the insured's file, and/or providing a copy of the visual diagram to the insured.

In other select embodiments, the method of training multiline insurance agents may also include assessing the performance of the multiline insurance agent in discovering the financial situation and risks of the insured. In select embodiments, this step of assessing the performance of the multiline insurance agent may include assessing the performance of the multiline insurance agent in the areas of:
the multiline insurance agent positioned itself as a risk advisor and properly transitioned into discovering the insured's financial situation and risks;
the multiline insurance agent asked about the insured's occupation and income and showed genuine interest in the insured;
the multiline insurance agent understands the insured's family and assets;
the multiline insurance agent summarized the insured's income, family, and assets and asked if the multiline insurance agent missed anything;
the multiline insurance agent transitioned into the list of risks;
the multiline insurance agent discussed each risk area and documented the insured's coverage in each risk area;
the multiline insurance agent drew the wall of protection and asked the insured to prioritize the listing of risks;
the multiline insurance agent asked the insured for introductions;
the conversation was natural; or
combinations thereof.

In other select embodiments, this step of assessing the performance of the multiline insurance agent may include using a questionnaire with a five-point scale for assessing performance in such areas listed above.

These and other features of the method of training multiline insurance agents will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present method of training multiline insurance agents will be better understood by reading the Detailed Description with reference to the accompanying drawings, which are not necessarily drawn to scale, and in which like reference numerals denote similar structure and refer to like elements throughout, and in which:

FIG. 1 is a flow diagram of an embodiment of the method of training a multiline insurance agent according to the instant disclosure;

FIG. 2 is a schematic diagram of a sample embodiment of the visual diagram of the insured's financial situation and risks according to the instant disclosure; and

FIG. 3 is a sample embodiment of a questionnaire with a five-point scale for assessing the performance of the multiline insurance agent according to the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

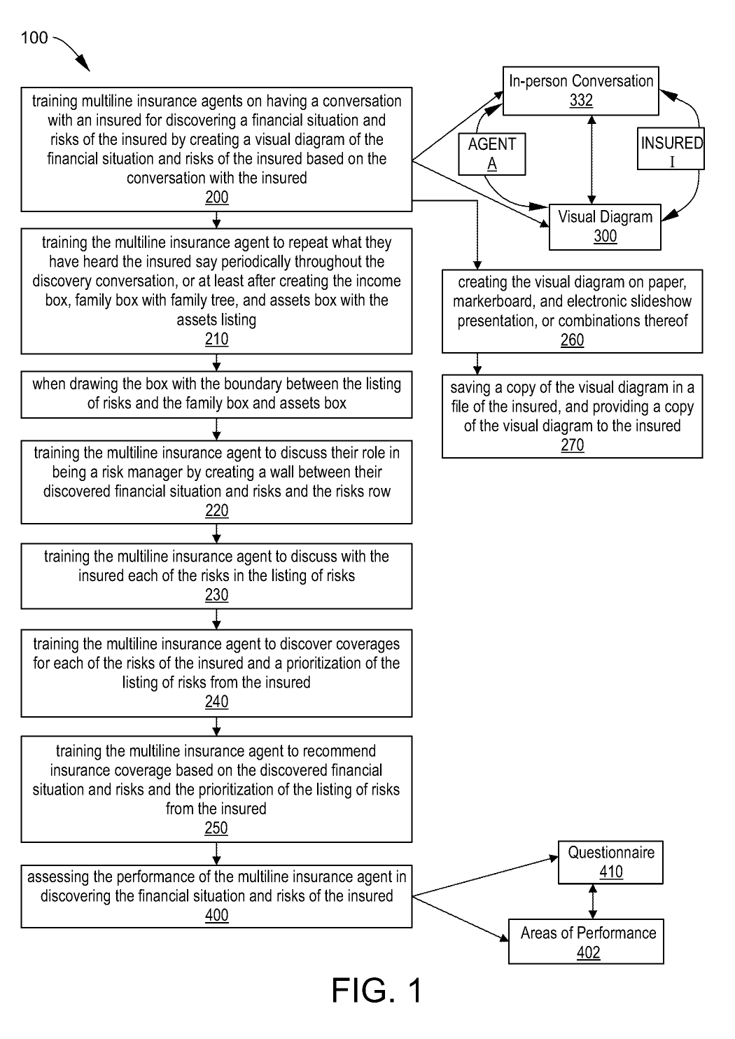

In describing the exemplary embodiments of the present disclosure, as illustrated in FIGS. 1-3, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

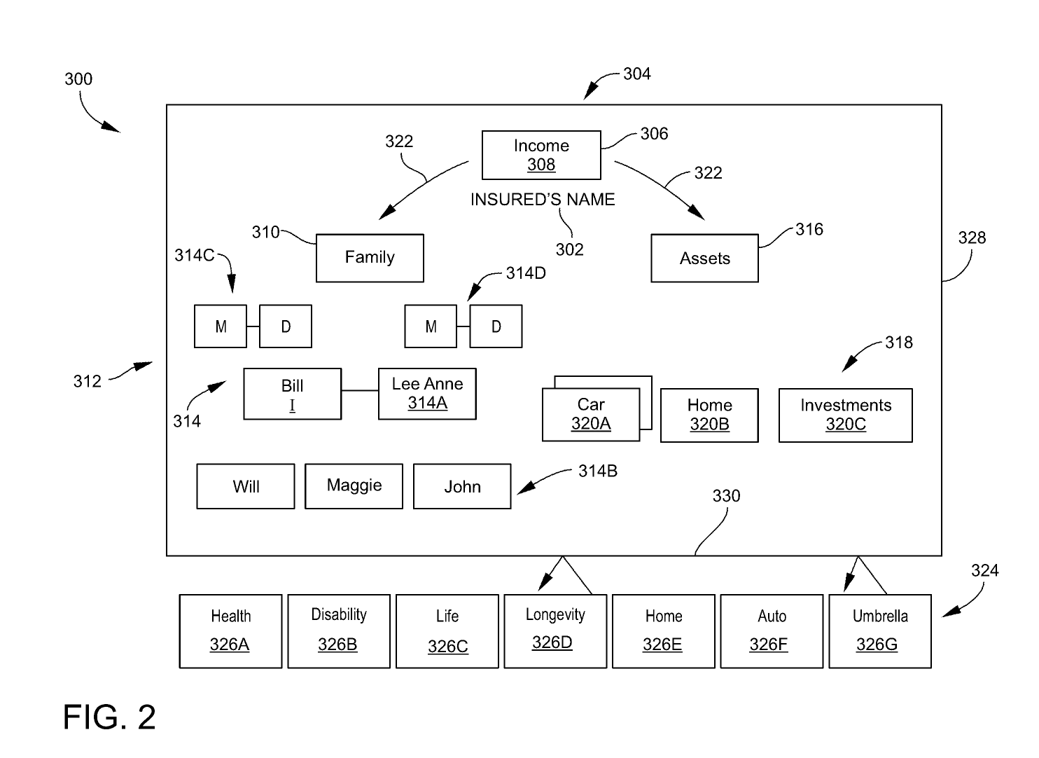

Referring now to FIG. 1 by way of example, and not limitation, therein is illustrated an example embodiment of method 100 of training a multiline insurance agent A. Method 100 may generally include step 200 of training multiline insurance agent A on having a conversation with an insured I for discovering an insured's financial situation and risks. This discovery is enabled by creating visual diagram 300 (as shown in FIG. 2) of the insured's financial situation and risks based on the conversation with the insured I. The visual diagram 300 drawn based on the conversations with the insured I in method 100 may be trained to the multiline insurance agent A to help in the discovery and understanding of the client's financial situation and risks. The visual diagram 300 of the insured's financial situation and risks may be created based on an in-person conversation 332 between the multiline insurance agent A and the insured I. Based on these conversations with the multiline insurance agent's clients I, diagram 300 may provide a repeatable framework that the multiline insurance agent A may utilize over and over again with various insured clients I and at various times in their life's to discover and understand the client's financial situations and risks. In addition, visual diagram 300 may provide a visual representation to the client of their financial situations and risks and aid in their understanding of their assets and associated risks, and what the multiline insurance agent A is recommending and providing.

Prior to drawing diagram 300, method 100 of training a multiline insurance agent A may include the step of training the agent A to position his or her self as an advisor. This step may include any techniques for positioning the multiline agent A to position itself as an advisor. As examples, and clearly not limited thereto, the agent A may be trained to have conversations like:
“Thank you for coming in. First I want you to know that we are a little different from other companies. We help customers manage their everyday risk. No in order to do that properly, I may have to ask you some personal questions. But I promise you that once we are done, you're going to have a better picture of what your financial situation and risks look like. Does that make sense? Great. Let's get started”;
“You are the center of your financial situation and risks and everybody loves you for a variety of reasons. One of those reasons is because you create income . . . ”;
“Tell me about you and what you do for a living, how long and how much do you make? (If you are married, what does your spouse do, how long, and how much?)”,
the like, etc.

Referring now to FIG. 2, diagram 300 drawn utilizing method 100 may generally include an insured's name 302 at a center 304 of the visual diagram 300. Along with the insured's name 300, an income box 306 of the insured's household income 308 may be included at the center 304 of the visual diagram 300. This household income 308 may be discovered based on discussions about the insured's occupation and earnings along with the occupation and/or earnings of the insured's spouse 312A.

A family box 310 may then be branched off from the income box 306 with a family tree 312 of the insured's family thereunder in visual diagram 300. The family tree 312 created in the visual diagram 300 may include any members of the insured's family or any other individuals or entities that the insured cares for or takes responsibility for, including, but not limited to: the insured I, the spouse 312A, any children 312B, any parents 312C of the insured I, any parents 312D of the insured's spouse, the like, combinations thereof, or any other individuals inside or outside of the insured's family that the insured desires to disclose that they may have liability or risk associated with. In select embodiments, the family tree 312 may consist of: the insured I, the spouse 312A, their children 312B if applicable, the insured's parents 312C if applicable, and the spouse's parents 312D if applicable.

An assets box 316 may also be branched off from the income box 306 with an assets row 318 of the insured's assets 320 listed therein within visual diagram 300. The insured's assets 320 listed in the assets row 318 may be any assets of the insured, including, but not limited to: a car or cars 320A including a car type and a car value, a home or homes 320B including a home value, investments 320C including an investment type and an investment value, the like, combinations thereof, or any other various assets the insured may disclose. In select embodiments, the insured's assets 320 listed in the assets row 318 may consist of: the car or cars 320A, the home or homes 320B, and the investments 320C.

As shown in FIG. 2, the family box 310 and the assets box 316 may be branched off from the income box 306 in different directions to show the two different areas that the insured I may use their household income 308 for supporting family and purchasing assets. This visualization may aid in the insured I understanding the two areas his household income 308 is distributed. As such, method 100 of training a multiline insurance agent A may include the step of training the agent A to have conversations like:
“Your income goes in one of two directions—either to support your family or to purchase assets.”;
“Tell me about your family. (You, your spouse or significant other, kids, parents, pets). What are their names and ages?”;
“Tell me about your assets (car(s), home(s), retirement plans, investments, toys, valuables, etc.)”;
“Thanks for sharing that with me, here's what I heard you say . . . ”(summarize their situation)”; “As a risk advisor, I think about seven-things. The seven biggest risks we all face . . . ”,
“The first thing I think about is your health. If you have a major medical procedure, it could cost a lot of money and I don't want anything to erode your assets (or create debt). Tell me about your health care coverage”;
“The second thing I think about is your income. If you became sick or injured and couldn't work for six months, would your financial situations and risks be ok? (if not, we should talk about disability)”;
The third thing I think about is if something happened to you permanently. Would your financial situations and risks be ok? (If not, we should talk about your life insurance)”;
“The fourth think I think about is just the opposite. If you live a really long time, is it possible you could outlive your assets? I call that a longevity risk, and if you have that concern, I'll be happy to talk with you about your retirement plan and long term care and I can recommend some ways you will never outlive your assets”;
“The fifth thing I think about is your home. I want to make sure your liability limits are where they need to be”;
“The sixth thing I think about is your cars. If you were to be involved in an accident I want to make sure your liability limits are where they need to be so that you can transfer all of the risk to us and there will be no risk to you”;
“And the last thing I think about is if you or an of your family members caused an accident, and there were injuries and you were sued for $1 million, would your financial situations and risks be ok? (If not, we should be talking about a Personal Liability Umbrella Policy)”;
“As your risk advisor, my job is to help you build a wall of protection around your financial situations and risks, so that nothing can impact it. If any of these risks occur, they will bounce right off”;
“Obviously we are not going to build this wall today, but my goal is to help you build it over time. My only question is, which of these risk concern you the most, and where would you like to start?”
the like, etc.

A risks row 324 may then be created at the bottom of the diagram 300. The risks row 324 may include the insured's risks 326 listed therein. The insured's risks 326 listed in the risks row of visual diagram 300 may be any risks of the insured I, including, but not limited to: health 326A, disability 326B, life 326C, longevity 326D, home 326E, auto 326F, liability 326G for umbrella coverage (i.e. liability not covered by other policies of the insured), the like, combinations thereof, and any other risks associated with the insured I. In select embodiments, the listing of risks may consist of: health 326A, disability 326B, life 326C, longevity 326D, home 326E, auto 326F, and liability 326G.

A box 328 may then be drawn around the insured's name 302, the income box 306, the family box 310 with the family tree 312, and the assets box 316 with the assets row 318, where the box 328 provides a boundary 330 between the risks row 324 and the family box 310 and assets row 318.

Referring now back to FIG. 1, another feature of method 100 of training multiline insurance agent A, may be that in select embodiments the visual diagram may be created in step 260 on paper, markerboard, an electronic slideshow presentation, the like, combinations thereof, or other various means for creating a visual representation of the insured's financial situation and risks. Once created, in select embodiments, the method 100 may further include step 270 of saving a copy of the visual diagram 300 in the insured's file, and/or providing a copy of the visual diagram to the insured. Saving a copy of the visual diagram 300 to the insured's file can provide a quick tool for the multiline insurance agent A to pull out or review for recalling any of the information in the visual diagram 300. In addition, having a copy of the visual diagram 300 available to the insured I for them to take home and review and store, should provide for added convenience to the insured I and aid in building and maintaining the relationship with the insured I. For example, if the visual diagram 300 is created on paper, the paper version of visual diagram 300 may be scanned in and saved under the client's file. In addition, a copy of the paper version may be given to the insured I. As another example, if the visual diagram 300 is created on markerboard, the markerboard version of visual diagram 300 may be captured in a photo, where the photo is saved under the client's file. In addition, a copy of the photo with the markerboard version of visual diagram 300 may be given to the insured I. As yet another example, if the visual diagram 300 is created in an electronic slideshow presentation, a digital copy of the electronic slideshow presentation version of the visual diagram 300 can be saved to the client's file. In addition, a print out or additional electronic copy of this electronic slideshow presentation version of the visual diagram 300 can be given to the insured I.

Still referring to FIG. 1, in select embodiments of method 100 of training the multiline insurance agent A may include step 210 of training the agent A to repeat what they have heard the insured I say periodically throughout the discovery conversation. This repeating may occur at any point in the conversation or discovery process. In select embodiments, this repeating of what the agent A heard may occur at least after creating the income box 306, family box 310 with family tree 312, and assets box 316 with the assets listing 318. This step 210 of repeating of what they have heard may be for letting the insured I know they were listening and for assuring the accuracy of the insured's discovered financial situation and risks.

In other select embodiments, the method 100 of training the multiline insurance agent A may also include step 220 of training the multiline insurance agent A to discuss their role in being a risk manager by creating a wall or boundary between their discovered financial situation and the insured's risks. This discussion in step 220 may take place anytime in method 100 including before, after, and/or during the discovery conversations. In a preferred embodiment, this step 220 may take place when drawing box 328 with boundary 330 between the listing of risks 326 and the family box 310 and the assets box 316. By emphasizing their roles as a risk manager when creating boundary 330, box 328 and its lower boundary 330 may help aid and visualize to the insured I by creating a wall or boundary 330 between their discovered financial situation and the insured's risks in the risks row 324.

In other select embodiments, the method 100 of training the multiline insurance agent A may also include step 230 of training the multiline insurance agent A to discuss with the insured I each of their risks in the risks row and discover the insured's coverage for each of their risks and a prioritization of the listing of risks from the insured I. This discussion will aid in the agents A understanding of the financial situation and risks of the insured I, thereby making their recommendations for coverage and insurance more personalized to the insured I.

In other select embodiments, the method 100 of training the multiline insurance agent A may also include step 240 of training the multiline insurance agent A to recommend insurance coverage based on the discovered financial situation and risks and the insured's prioritization of the listing of risks. Again, these recommendations of coverage from the multiline insurance agent A will be personalized to the insured I based on the discussions and discovery had during method 100.

In other select embodiments, the method 100 of training the multiline insurance agent A may also include step 400 of assessing the performance of the multiline insurance agent A in discovering the financial situation and risks of the insured I. In select embodiments, this step 400 of assessing the performance of the multiline insurance agent A may include assessing the performance of the multiline insurance agent in various areas 402. These areas 402 assessed in method 100 of training the multilevel insurance agent A may be any desired areas, including, but not limited to:
area 402A of the multiline insurance agent positioned itself as a risk advisor and properly transitioned into discovering the insured's financial situation and risks;
area 402B of the multiline insurance agent asked about the insured's occupation and income and showed genuine interest in the insured;
area 402C of the multiline insurance agent understands the insured's family and assets;
area 402D of the multiline insurance agent summarized the insured's income, family, and assets and asked if the multiline insurance agent missed anything;
area 402E of the multiline insurance agent transitioned into the list of risks;
area 402F of the multiline insurance agent discussed each risk area and documented the insured's coverage in each risk area;
area 402G of the multiline insurance agent drew the wall of protection and asked the insured to prioritize the listing of risks;
area 402H of the multiline insurance agent asked the insured for introductions;
area 404I of the conversation was natural;
the like, or combinations thereof.

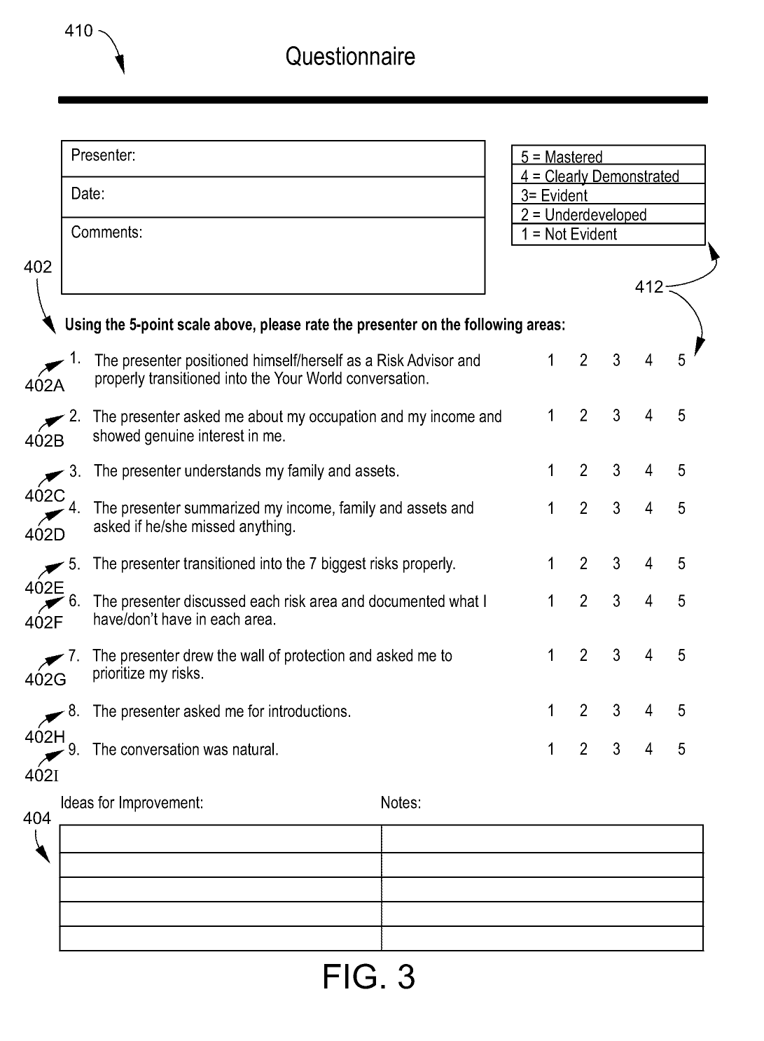

Referring now to FIG. 3, in select embodiments, step 400 of assessing the performance of the multiline insurance agent A may include using questionnaire 410. Questionnaire 410 may be utilized for testing and assessing the performance of the multiline insurance agent A in performing any and/or all of the steps or processes associated with method 100 disclosed herein. Questionnaire 410 may include any style, format, etc. for testing and assessing the performance of multiline insurance agent A. In select embodiments, as shown in FIG. 3, questionnaire 410 may include five-point scale 412 for assessing the performance of multiline insurance agent A. For example, five-point scale 412 may include: a five rating for mastering an area of performance; a four rating for clearly demonstrating an area of performance; a three rating for evidence of an area of performance; a two rating for underdeveloped area of performance; and a one rating for no evidence of an area of performance. In this example, the higher the score, the better the multiline insurance agent A performed. Questionnaire 410 may also include an area 404 for free form entry of areas of improvement and/or notes. In a specific example, as shown in FIG. 3, questionnaire 410 may include the five-point scale 412 for ratings in areas consisting of:
area 402A of the multiline insurance agent positioned itself as a risk advisor and properly transitioned into discovering the insured's financial situation and risks;
area 402B of the multiline insurance agent asked about the insured's occupation and income and showed genuine interest in the insured;
area 402C of the multiline insurance agent understands the insured's family and assets;
area 402D of the multiline insurance agent summarized the insured's income, family, and assets and asked if the multiline insurance agent missed anything;
area 402E of the multiline insurance agent transitioned into the list of risks;
area 402F of the multiline insurance agent discussed each risk area and documented the insured's coverage in each risk area;
area 402G of the multiline insurance agent drew the wall of protection and asked the insured to prioritize the listing of risks;
area 402H of the multiline insurance agent asked the insured for introductions; and
area 404I of the conversation was natural.

Method 100 of training multiline insurance agent A may be conducted alone or along with any other training. For example, method 100 may also include training multiline insurance agent A to position itself as a trusted advisor, like training them to talk with a customer or prospective customer, as soon as possible, and to position itself as a trusted advisor by saying something similar to “I help people manage their everyday risk” or “We're a little different, we help people manage their everyday risk”. As most people do not know what everyday risk is, the typical response will be “What's that mean?”.

As another example, method 100 may also include training multiline insurance agent A to demonstrate its ability to help. The best way to answer the question mentioned before of, “What does everyday risk mean”, is by sharing an example with a client attraction story, like a story where a client required umbrella protection, or had liability above any of their other coverages. Such stories may be advantageous for demonstrating the agent's ability to help by: 1) illustrating a devastating risk, how to avoid it, and why the client should have a good risk advisor; 2) only 3% of US households have a good risk advisor; 3) umbrellas are inexpensive; and 4) no one has to die.

As yet another example, method 100 may also include training multiline insurance agent A to set the meeting. This step may include instructions on how to dismount from the client attraction story and set an appointment for discovering the client's financial situation and risks. Agents may be trained to tell the insured client that they would be happy to understand their complete situation and recommend the most effective way to protect everything they own. Some questions to aid in setting the appointment may include, but are not limited to: “Would you like me to do that for you?”; “How did you hear about us?”; “Who set your liability limits”; “You mean nobody ever talked with you about your home and your cars and your savings and how it all fits together and the best way to protect it?”; and/or “Oh, well I'll be happy to get you a quote today, but I want to go ahead and schedule a time for you to come in and meet with me. I'll show you how everything in your financial situation and risks fits together and the most effective way to protect it. When would you like to come in?”. The agent could be trained to: onboard new customers with appointments for discovering the financial situation and risks of the client; turn service calls into appointments for discovering the financial situation and risks of the client; discuss with client's the agents new training in discovering the financial situation and risks of the client in a visual diagram; discuss with the client that the agent would be happy to create a visual diagram of their financial situation and risks; train the agent to call the customer when rates increase and suggest setting up a time to discuss the client's financial situation and risks; set automatic appointments when rates change; set appointments with emails or letters for discussing the client's financial situation and risks.

As yet another example, method 100 may also include training multiline insurance agent A to ask for referrals. After conducting the conversations for discovering the client's financial situation and risks and creating the visual diagram 300, the client might say thank you. Regardless, the agent A should be trained to ask for referrals by suggesting they have the same discovery conversation with anyone the client knows that could benefit, like friends or family. As examples, and clearly not limited thereto, method 100 of training the multiline insurance agent A may include training the agent A to ask for referrals with the following conversations:
1. Ask, “was this conversation helpful?” (yes)
2. “Oh, that's great. This is the favorite part of my job.”
3. “I have a HUGE favor to ask.”
4. “I want to build my agency with customers just like you.”
5. “I'm going to go make a copy of this diagram (diagram 300), while I'm gone, if I could get the names of three people just like you, that would enjoy this the way you did it would be a huge favor to me. Be right back.”
   The agent A could then be trained to leave the room and stay gone for a couple of minutes. When the Agent A comes back, hopefully there will be 3 names on the piece of paper.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A method of training a multiline insurance agent comprising:
training multiline insurance agents on having a conversation with an insured for discovering a financial situation and risks of the insured by creating a visual diagram of the financial situation and risks of the insured based on the conversation with the insured, said visual diagram comprising:
a name of the insured at a center of the visual diagram including an income box of a household income of the insured;
a family box branched off from the income box with a family tree of a family of the insured thereunder;
an assets box branched off from the income box with an assets row of assets of the insured listed therein;
wherein the family box and assets box being branched off from the income box in different directions to show the two different areas that the insured uses income for supporting family and purchasing assets;
a risks row at the bottom of the diagram with risks of the insured listed therein; and
a box drawn around the name, the income box, the family box with the family tree, and the assets box with the assets row, where the box provides a boundary between the risks row and the family box and the assets row.

2. The method of training a multiline insurance agent of claim 1, wherein the visual diagram of the financial situation and risks of the insured is created based on an in-person conversation between the multiline insurance agent and the insured.

3. The method of training multiline insurance agents of claim 1 further including training the multiline insurance agent to repeat what they have heard the insured say periodically throughout the discovery conversation, or at least after creating the income box, family box with family tree, and assets box with the assets listing, for letting the insured know they were listening and for assuring the accuracy of the discovered financial situation and risks of the insured.

4. The method of training multiline insurance agents of claim 1 further comprising, when drawing the box with the boundary between the listing of risks and the family box and assets box, training the multiline insurance agent to discuss their role in being a risk manager by creating a wall between their discovered financial situation and risks and the risks row.

5. The method of training multiline insurance agents of claim 1 further including training the multiline insurance agent to discuss with the insured each of the risks in the listing of risks and discover coverages for each of the risks of the insured and a prioritization of the listing of risks from the insured.

6. The method of training multiline insurance agents of claim 5 further comprising training the multiline insurance agent to recommend insurance coverage based on the discovered financial situation and risks and the prioritization of the listing of risks from the insured.

7. The method of training multiline insurance agents of claim 1, wherein the risks of the insured listed in the risks row include:
health;
disability;
life;
longevity;
home;
auto;
liability; or
combinations thereof.

8. The method of training multiline insurance agents of claim 7, wherein the listing of risks consists of:
health;
disability;
life;
longevity;
home;
auto; and
liability.

9. The method of training multiline insurance agents of claim 1, wherein the family tree includes:
the insured;
a spouse;
children;
parents;
spouse's parents; or
combinations thereof.

10. The method of training multiline insurance agents of claim 9, wherein the family tree consists of:
the insured;
the spouse;
children;
parents; and
spouse's parents.

11. The method of training multiline insurance agents of claim 1, wherein the assets of the insured listed in the assets row include:
a car or cars including type and value;
a home or homes including value;
investments including type and value; or
combinations thereof.

12. The method of training multiline insurance agents of claim 11, wherein the asset listing consists of:
the car or cars including type and value;
the home or homes including value; and
investments including type and value.

13. The method of training multiline insurance agents of claim 1, wherein the visual diagram is created on paper, markerboard, an electronic slideshow presentation, or combinations thereof.

14. The method of training multiline insurance agents of claim 13 further including saving a copy of the visual diagram in a file of the insured, and providing a copy of the visual diagram to the insured.

15. The method of training multiline insurance agents of claim 1 further comprising assessing the performance of the multiline insurance agent in discovering the financial situation and risks of the insured.

16. The method of training multiline insurance agents of claim 15, wherein the step of assessing the performance of the multiline insurance agent including assessing performance in the areas of:
the multiline insurance agent positioned himself/herself as a risk advisor and properly transitioned into discovering the financial situation and risks of the insured;
the multiline insurance agent asked about an occupation and income of the insured and showed genuine interest in the insured;
the multiline insurance agent understands the family and the assets of the insured;
the multiline insurance agent summarized the income, the family, and the assets of the insured, and asked if the multiline insurance agent missed anything;
the multiline insurance agent transitioned into the list of risks;
the multiline insurance agent discussed each risk area and documented the coverages of the insured in each risk area;
the multiline insurance agent drew the wall of protection and asked the insured to prioritize the listing of risks;
the multiline insurance agent asked the insured for introductions;
the conversation was natural; or
combinations thereof.

17. A method of training a multiline insurance agent comprising:
training multiline insurance agents on having a conversation with the insured for discovering the financial situation and risks of the insured by creating a visual diagram of the financial situation and risks of the insured based on the conversation with the insured; and
assessing the performance of the multiline insurance agent in discovering the financial situation and risks of the insured including assessing performance in the areas of:
the multiline insurance agent positioned himself/herself as a risk advisor and properly transitioned into discovering the financial situation and risks of the insured;
the multiline insurance agent asked about the occupation and the income of the insured, and showed genuine interest in the insured;
the multiline insurance agent understands the family and the assets of the insured;
the multiline insurance agent summarized the income, the family, and the assets of the insured, and asked if the multiline insurance agent missed anything;
the multiline insurance agent transitioned into the list of risks;
the multiline insurance agent discussed each risk area and documented the coverages of the insured in each risk area;
the multiline insurance agent drew the wall of protection and asked the insured to prioritize the listing of risks;
the multiline insurance agent asked the insured for introductions;
the conversation was natural;
ideas for improvement; or
combinations thereof.

18. The method of training multiline insurance agents of claim 17, wherein the step of assessing the performance of the multiline insurance agent including using a questionnaire with a five-point scale for assessing performance in the areas of:
the multiline insurance agent positioned himself/herself as a risk advisor and properly transitioned into discovering the financial situation and risks of the insured;
the multiline insurance agent asked about the occupation and the income of the insured, and showed genuine interest in the insured;
the multiline insurance agent understands the family and the assets of the insured;
the multiline insurance agent summarized the income, the family, and the assets of the insured, and asked if the multiline insurance agent missed anything;
the multiline insurance agent transitioned into the list of risks;
the multiline insurance agent discussed each risk area and documented the coverages of the insured in each risk area;
the multiline insurance agent drew the wall of protection and asked the insured to prioritize the listing of risks;
the multiline insurance agent asked the insured for introductions; and
the conversation was natural.

19. The method of training multiline insurance agents of claim 17, wherein said visual diagram comprising:
the name of the insured at the center of the visual diagram including an income box of a household income of the insured;
a family box branched off from the income box with a family tree of a family of the insured thereunder;
an assets box branched off from the income box with an asset listing of assets of the insured listed thereunder;
wherein the family box and assets box being branched off from the income box in different directions to show the two different areas that the insured uses income for supporting family and purchasing assets;
a listing of risks at the bottom of the diagram; and
a box drawn around the name, the income box, the family box with the family tree, and the assets box with the asset listing, where the box provides a boundary between the listing of risks and the family box and the assets box;
wherein the visual diagram of the financial situation and risks of the insured is created based on an in-person conversation between the multiline insurance agent and the insured.

20. A method of training a multiline insurance agent comprising:
training multiline insurance agents on having a conversation with an insured for discovering a financial situation and risks of the insured by creating a visual diagram of the financial situation and risks of the insured based on the conversation with the insured;
wherein the visual diagram of the financial situation and risks of the insured is created based on an in-person conversation between the multiline insurance agent and the insured;
said visual diagram comprising:
a name of the insured at the center of the visual diagram including an income box of a household income of the insured;
a family box branched off from the income box with a family tree of a family of the insured thereunder, wherein the family tree consists of:
the insured;
a spouse;
children;
parents; and
spouse's parents;
an assets box branched off from the income box with an asset listing of assets of the insured listed thereunder wherein the asset listing consists of:
a car;
a home; and
investments;
wherein the family box and assets box being branched off from the income box in different directions to show the two different areas that the insured uses income for supporting family and purchasing assets;
a listing of risks at the bottom of the diagram, wherein the listing of risks consists of:
health;
disability;
life;
longevity;
home;
auto; and
liability; and
a box drawn around the name of the insured, the income box, the family box with the family tree, and the assets box with the asset listing, where the box provides a boundary between the listing of risks and the family box and the assets box;
wherein the visual diagram is created on paper, markerboard, an electronic slideshow presentation, or combinations thereof;
saving a copy of the visual diagram in a file of the insured, and providing a copy of the visual diagram to the insured;
training the multiline insurance agent to repeat what they have heard the insured say periodically throughout the discovery conversation, or at least after creating the income box, family box with family tree, and assets box with the assets listing, for letting the insured know they were listening and for assuring the accuracy of the discovered financial situation and risks of the insured;
when drawing the box with the boundary between the listing of risks and the family box and assets box, training the multiline insurance agent to discuss their role in being a risk manager by creating a wall between their discovered financial situation and risks and the listing of risks;
training the multiline insurance agent to discuss with the insured each of the risks in the listing of risks and discover coverages of the insured for each of the risks and a prioritization of the listing of risks from the insured;
training the multiline insurance agent to recommend insurance coverage based on the discovered financial situation and risks and the prioritization of the listing of risks from the insured; and
assessing the performance of the multiline insurance agent in discovering the financial situation and risks of the insured including assessing performance using a questionnaire with a five-point scale for assessing performance in the areas of:
the multiline insurance agent positioned himself/herself as a risk advisor and properly transitioned into discovering the financial situation and risks of the insured;
the multiline insurance agent asked about an occupation of the insured and income of the insured, and showed genuine interest in the insured;
the multiline insurance agent understands the family and assets of the insured;
the multiline insurance agent summarized the income, the family, and assets of the insured, and asked if the multiline insurance agent missed anything;
the multiline insurance agent transitioned into the list of risks;
the multiline insurance agent discussed each risk area and documented the coverages of the insured in each risk area;
the multiline insurance agent drew the wall of protection and asked the insured to prioritize the listing of risks;
the multiline insurance agent asked the insured for introductions; and
the conversation was natural.
